(19) United States
(12) Patent Application Publication
(10) Pub. No.: US 2026/0359903 A1
(43) Pub. Date: Nov. 12, 2026

(54) POWER GENERATION CONTROL DEVICE, UNIT PRICE DETERMINATION DEVICE, POWER SUPPLY CONTROL SYSTEM, POWER GENERATION CONTROL METHOD, AND PROGRAM

(71) Applicant: MITSUBISHI HEAVY INDUSTRIES, LTD., Tokyo (JP)

(72) Inventors: Takaharu HIROE, Tokyo (JP); Ryo SASE, Tokyo (JP)

(73) Assignee: MITSUBISHI HEAVY INDUSTRIES, LTD., Tokyo (JP)

(21) Appl. No.: 19/122,524

(22) PCT Filed: Oct. 27, 2023
(86) PCT No.: PCT/JP2023/038915

§ 371 Date: Apr. 18, 2025

(30) Foreign Application Priority Data
Dec. 16, 2022 (JP) 2022-200958

(51) Int. Cl. G06Q 50/06; H02J 3/38; H02J 3/46; H02J 101/24; H02J 101/28; H02J 103/30

(52) U.S. Cl. CPC G06Q 50/06; H02J 3/381; H02J 3/46; H02J 2101/24; H02J 2101/28; H02J 2103/30

(57) ABSTRACT

According to the present invention, a power generation control device installed at each of a plurality of power plants comprises: an optimal value determination unit that determines an optimal value for the electrical output of the power plant on the basis of the unit price of generated power supplied to a power system; and an adjustment unit that adjusts a command value of the electrical output in accordance with the frequency of the power system, with the optimum value as the upper limit of the electrical output.

### TECHNICAL FIELD

The present disclosure relates to a power generation control device, a unit price determination device, a power supply control system, a power generation control method, and a program in a power system in which power generation is liberalized and a plurality of independent power generation companies supply generated power.

This application claims the priority of Japanese Patent Application No. 2022-200958 fled in Japan on Dec. 16, 2022, the contents of which are incorporated herein by reference.

### BACKGROUND ART

In the related art, a power system has been operated by substantially one electric power company for each region. The electric power company in the region owns an enough number of power plants to meet the power demand in the region, and plays a role of covering the power demand in the region with the minimum fuel cost by adjusting a load distribution of the power plants. A large number of power plants have different fuel cost characteristics for each power plant, and even when a total power generation amount is the same, the total fuel cost depends on the quality of the load distribution to the power plants. It is important for the electric power company to adjust the load distribution to the power plants to meet the power demand in the region with the minimum fuel cost.

When the load distribution that minimizes the fuel cost is referred to as an optimal load distribution, the optimal load distribution of the power plant can generally be obtained by an equal incremental fuel cost method. A property widely known in economics as the taw of increasing marginal costs, which is the property in which the additional cost required to add one unit of power generation amount, that is, utility, increases together with the utility, also applies to the power plant. The equal incremental fuel cost method uses this property to determine the optimal load distribution of the power plant that is in operation. Therefore, in the related art, an electric power company determines a combination of power plants to be operated, and then distributes a load in accordance with an equal incremental fuel cost method to save a fuel cost (for example, see PTL 1).

### CITATION LIST

### Patent Literature

[PTL 1] Japanese Examined Patent Application Publication No. 63-066144

### SUMMARY OF INVENTION

### Technical Problem

In recent years, the power generation in the power system is liberalized, and the power is supplied to each region from a power plant of a traditional electric power company and a power plant of a new independent, power generation company. The traditional electric power company is also one of the independent power generation company, and shares the demand in the region with a plurality of independent power generation companies. The power system generates the power in accordance with the demand. For the power generation company, the demand is given, and the total power generation amount of the entire power generation company is also given. Therefore, assuming that the demand is constant, for example, when a certain power generation company increases the power generation amount for the purpose of improving the profit, another power generation company reduces the power generation amount so that the demand and the supply match. Although it is not often considered, it will cause a deterioration in profit for the company that reduces the power generation amount for supply and demand adjustment.

In an era where the power plants in the region belong to one power generation company, the profit of each power plant is not important, and thus one power generation company only needs, for example, to distribute the total power generation amount that meets the demand in the region to the power plant with the minimum fuel cost. However, when a large number of power generation companies share the demand in the region, fairness is also required in the way of sharing the demand.

In the power system in which the power generation is liberalized, each power plant may be a unit of the profit, and it is inevitable that each power plant acts selfishly to improve its own profit. Therefore, a technique is required in which the selfish action of each power plant is harmonized to meet the demand without excess or deficiency as a whole.

An object of the present disclosure is to provide a power generation control device, a unit price determination device, a power supply control system, a power generation control method, and a program that can adjust electric output in accordance with a unit price anti demand tier generated power while suppressing an unfair bias of a benefit or a disadvantage to some power generation companies in a power system in which each of a plurality of power generation companies supplies generated power.

### Solution to Problem

An aspect of the present disclosure relates to a power generation control device that is provided in each of a plurality of power plants, the power generation control device including: an optimal value determination unit that determines an optimal value of electric output of the power plant based on a unit price for generated power supplied to a power grid; and an adjustment unit that adjusts a command value of the electric output in accordance with a frequency of the power grid by using the optimal value as an upper limit of the electric output.

Another aspect of the present disclosure relates to a unit price determination device including: an aggregated value acquisition unit that acquires, from each of a plurality of power plants, an aggregated value of an optimal value of electric output in accordance with a unit price for generated power supplied to a power grid, and an aggregated value of an equilibrium point signal that is a value of the electric output adjusted such that a deviation between a frequency of the power grid and a reference frequency approaches zero, and a unit price determination unit that determines the unit price based on the aggregated value of the optimal value anti the aggregated value of the equilibrium point signal.

Still another aspect of the present disclosure relates to a power supply control system that controls power supplied to a power grid, the power supply control system including: the power generation control device according to the above-described aspect; and the unit price determination device according to the above-described aspect.

Still another aspect of the present disclosure relates to a power generation control method including: a step of determining an optimal value of electric output of the power plant based on a unit price for generated power supplied to a power grid, and a step of adjusting a command value of the electric output, in accordance with a frequency of the power grid by using the optimal value as an upper limit of the electric output.

Still another aspect of the present disclosure relates to a program causing a power generation control device provided in each of a plurality of power plants to execute: a step of determining an optimal value of electric output of the power plant based on a unit price for generated power supplied to a power grid; and a step of adjusting a command value of the electric output in accordance with a frequency of the power grid by using the optimal value a an upper limit of the electric output.

### Advantageous Effects of Invention

According to the above-described aspects, in the power system in which each of the plurality of power generation companies supplies the generated power, it is possible to adjust the electric output in accordance with the unit price and the demand for the generated power while suppressing the unfair bias of the benefit or the disadvantage to some power generation companies.

### BRIEF DESCRIPTION OF DRAWINGS

FIG. 1 is a diagram illustrating an overall configuration of a power supply control system according to a first embodiment.

FIG. 2 is a first block diagram illustrating a functional configuration of a power generation control device according to the first embodiment.

FIG. 3 is a second block diagram illustrating the functional configuration of the power generation control device according to the first embodiment.

FIG. 4 is a block diagram illustrating functional configurations of an aggregation device and a unit price determination device according to the first embodiment.

FIG. 5 is a diagram illustrating an overall configuration of a power supply control system according to a modification example of the first embodiment.

FIG. 6 is a diagram illustrating an overall configuration of a power supply control system according to a modification example of a second embodiment.

FIG. 7 is a block diagram illustrating a functional configuration of a power generation control device according to the second embodiment.

FIG. 8 is a first diagram illustrating a function of a reallocation device according to the second embodiment.

FIG. 9 is a second diagram illustrating the function of the reallocation device according to the second embodiment.

FIG. 10 is a diagram illustrating an example of a hardware configuration of a distribution device according to at least one embodiment.

### DESCRIPTION OF EMBODIMENTS

### First Embodiment

Hereinafter, a first embodiment will be described in detail with reference to the drawings.

### (Overall Configuration)

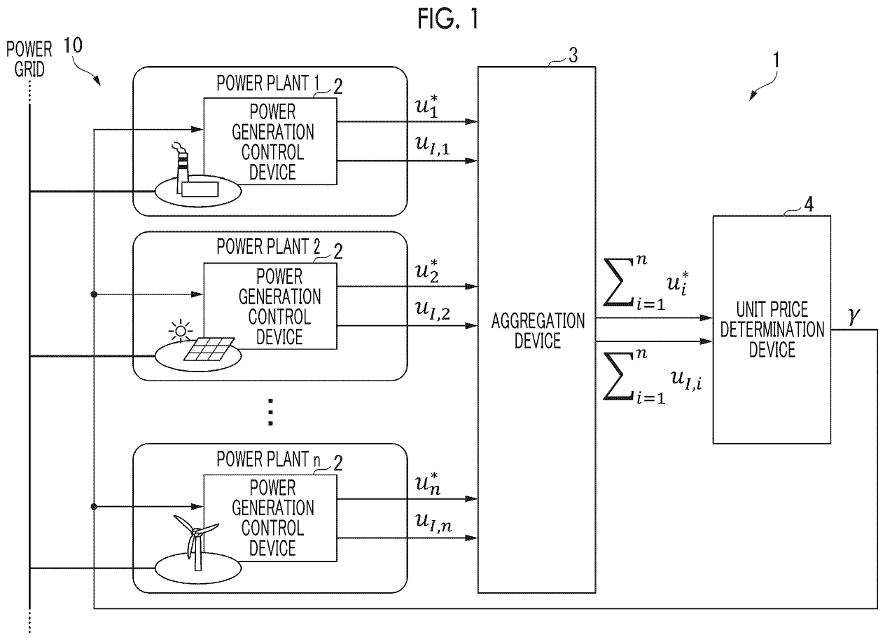

FIG. 1 is a diagram illustrating an overall configuration of a power supply control system according to the first embodiment.

FIG. 1 illustrates an example of a power system 10 in a certain region. The power system 10 according to the present embodiment is a power system in which the power generation is liberalized, and each of a plurality of power generation companies owns and operates one or more power plants and supplies power generated in each power plant to a power grid. For example, a plurality of power plants 1, 2, . . . , n illustrated in FIG. 1 may be owned and operated by different power generation locations. The power plant may be a power generation facility that uses natural energy such as solar power and wind power, in addition to a thermal power plant or a nuclear power plant.

The power supply control system 1 adjusts electric output of each power plant in the power system 10. The power supply control system 1 includes a power generation control device 2, an aggregation device 3, and a unit price determination device 4.

The power generation control device 2 is provided in each of the plurality of power plants 1, 2, . . . , n. The power generation control device 2 adjusts the electric output of the power plant in which the power generation control device 2 is installed, in accordance with a unit price γ for the generated power and the demand in the region (power grid).

The aggregation device 3 aggregates various types of information for the unit price determination device 4 to determine the unit price, from each power generation control device 2.

The unit price determination device 4 determines the unit price γ for the generated power in the region based on the information aggregated by the aggregation device 3.

### (Functional Configuration of Power Generation Control Device)

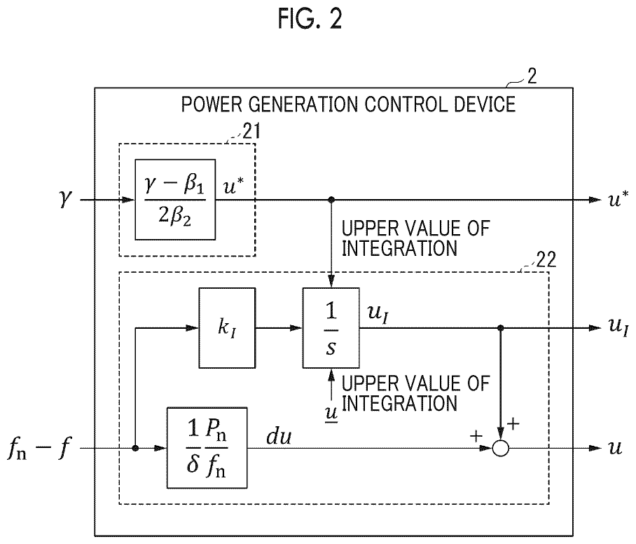

FIG. 2 is a first block diagram illustrating a functional configuration of the power generation control device according to the first embodiment.

The functional configuration of the power generation control device 2 will be described with reference to FIG. 2. The power generation control device 2 includes an optimal value determination unit 21 and an adjustment unit 22. The optimal value determination unit 21 determines AN optimal value u* of the electric output of the power plant based on the unit price γ for the generated power of the power grid. The adjustment unit 22 adjusts a command value u of the electric output in accordance with a frequency f of the power grid by using the optimal value u* of the electric output as an upper limit.

The processing of the power generation control device 2 will be described in detail. The electric output (command value) of the power plant, which is commanded by the power generation control device 2 to the power plant, is referred to as u. The electric output u [kW] of the power plant has a lower limit value u_ (u with an underline, and the same applies below) and an upper limit value u⁻ (u with an overline, and the same applies below). A power generation cost of the power plant is approximately expressed by the following Expression (1). The coefficients {β₂, β₁, β₀} represent a relationship between the electric output and the cost, and the values, thereof are determined for each power plant.

c=β₂u²+β₁u+β₀ (1)

The power generation cost, which is additionally generated when the electric output is increased by one unit, is referred to as a marginal cost m_{c}. Since the marginal cost m_{c} is obtained by differentiating the cost with respect to the electric output, the marginal cost m_{c} is expressed by the following Expression (2).

m_{c}=2β₂u+β₁ (2)

In general, the law of increasing marginal costs known in economics applies to the power generation cost for the electric output. The law of increasing marginal costs means that an additional cost (power generation cost) required to increase the utility (electric output) by one unit gradually increases. This means that the electric output per unit cost gradually decreases from the side of the electric output. When the power generation cost is approximately expressed by a quadratic expression as in Expression (1), the law of increasing marginal costs is equivalent to Expression (3). Expression (3) is also expressed as β₂>0, 2β₂u_+β₁>0.

$$\{ \begin{matrix}\frac{\partial c}{\partial u} > 0 \\ \frac{{\partial }^{2} c}{\partial {u}^{2}} > 0\end{matrix} , u ∈ [ \underline{u} , \overline{u} ] \qquad ( 3 )$$

In the power system in which the power generation is liberalized, the operation of the power plant is performed in accordance with the intention of the power generation company that owns the power plant. At least during normal times, the power generation company is free to operate/stop the power plant, and for example, another power generation company does not instruct the other power generation company to operate/stop. Therefore, the power plant to be operated is given as a whole. When the number of power plants in operation is n and the power generation cost of each of the power plants is expressed by Expression (1), an optimal load distribution of the power plants in operation, that is, optimal electric output of each power plant, is expressed as in Expression (4) with the marginal cost m_{c} as a parameter.

$${u}_{i}^{opt} ( {m}_{c} ) = \frac{{m}_{c} - {β}_{1 , i}}{2 {β}_{2 , i}} \qquad ( 4 )$$

Since the optimal load distribution only changes the distribution while maintaining the total amount of the power generation output, the value of the marginal cost m_{c} is obtained by Expression (5B) from Expression (5A).

$$\begin{matrix}{\sum }_{i = 1}^{n} {u}_{i} = {\sum }_{i = 1}^{n} {u}_{i}^{opt} ( {m}_{c} ) \\ = {m}_{c} {\sum }_{i = 1}^{n} \frac{1}{2 {β}_{2 , i}} - {\sum }_{i = 1}^{n} \frac{{β}_{1 , i}}{2 {β}_{2 , i}}\end{matrix} \qquad ( 5 A )$$

$${m}_{c} = \frac{{\sum }_{i = 1}^{n} {u}_{i} + {\sum }_{i = 1}^{n} \frac{{β}_{1 , i}}{2 {β}_{2 , i}}}{{\sum }_{i = 1}^{n} \frac{1}{2 {β}_{2 , i}}} \qquad ( 5 B )$$

When the marginal cost m obtained by Expression (5B) is substituted into Expression (4), it is immediately possible to know the electric output that each power plant has to share in order to obtain the total amount of the current electric output at the minimum cost for the entire power plant at the n locations. This is known as an equal incremental fuel cost method in an optimal operation of a power plant group. However, as described above, in the power system 10 in which the power generation is liberalized, the power plants owned by different power generation companies perform the power generation. For example, it is also conceivable that each power plant is owned by a separate power generation company. In such case, the first concern of each power generation company is probably its own profit. From the viewpoint of the overall efficiency, it is reasonable that a power plant with lower efficiency decreases the power generation output and another power plant with higher efficiency increases the electric output. However, in the power system in which the power generation is liberalized, such altruistic action cannot be expected. Each of the power generation companies will act selfishly to maximize its own profit. The power system requires a technique that accepts the action of the power generation company, which appears to be selfish, and harmonizes the actions to meet the demand for the power as a whole. This technique will be described below.

The profit of one power plant will be considered. When the unit price for the generated power is expressed by γ[¥/kWh], the profit p of the power plant is expressed by Expression (6).

p=γu−β₂u²−β₁u−β₀ (6)

Since the graph of Expression (6) is convex upward, the electric output u* at which the profit p is maximized is obtained as in Expression (7) by solving ∂p/∂u=0 for u.

$${u}^{*} = \frac{γ - {β}_{1}}{2 {β}_{2}} \qquad ( 7 )$$

The value of the unit price γ for the power is common to all the power plants, but the constants β₁ and β₂ representing the power generation costs are different for each power plant, so that the value of the electric output u* at which the profit p is maximized is different for each power plant. It should be noted that, in the power system 10 in which the power generation is liberalized, the power plant is not allowed to operate with the electric output u given by Expression (7). As in the related all, when there is substantially one huge electric power company in each region, the huge electric power company in the region adjusts the supply and demand for electric power. For this reason, even when another power generation company that is independent of the huge electric power company increases the power generation output in accordance with Expression (7) so that its own profit, is maximized, the disturbance of the power supply and demand balance caused due to the increase is offset by the huge electric power company, in the region, which reduces the power generation output. However, it is not fair to place the duty of adjusting the disturbance of the supply and demand balance on a specific electric power company. Since the power system cannot be established when each power plant increases the output at will, a technique is required in which each power generation company fairly shares the duty of adjusting the supply and demand.

As a technique of performing the above, in the present embodiment, the power generation control device 2 illustrated in FIG. 2 is used to adjust the electric output of each power plant. The power generation control device 2 is characterized in that the output of the power plant increases and decreases in accordance with the demand for the power. That is, the power generation control device 2 performs control of increasing the electric output of the power plant as the power demand increases and decreasing the electric output of the power plant as the power demand decreases.

The optimal value determination unit 21 of the power generation control device inputs the unit price γ for the generated power. The power generation control device 2 records the constants {β₂, β₁, β₀} representing the cost of the power plant, and the optimal value determination unit 21 determines the optimal value u* of the electric output at which the profit of the power plant is maximized, based on Expression (7).

In addition, the feature of the present embodiment is that the optimal value u* is not set as a target value of the electric output, but the optimal value u* is set as the upper limit value of the electric output. The adjustment unit 22 of the power generation control device 2 determines the equilibrium point signal u₁ of the electric output of the power plant. The adjustment unit 22 changes the equilibrium point signal u₁ between the lower limit value u_ of the electric output and the upper limit value u* of the electric output in accordance with an imbalance in the power supply and demand. It is known that the imbalance in the power supply and demand is manifested in a fluctuation in a frequency f of an alternating current. The frequency f of the power grid is maintained at a reference frequency fₙ. For example, in a case where the reference frequency fₙ is 60 Hz, when the supply of the power is insufficient for the demand for the power, the frequency f of the alternating current is lower than 60 Hz. and when the supply of the power exceeds the demand for the power, the frequency f of the alternating current is higher than 60 Hz. Using this property, in the power grid, each power plant adjusts the electric output in proportion to a difference between the frequency f and the reference frequency fₙ as in Expression (8). Here, uₙ is a reference electric output [kW] of the power plant, fₙ is a reference frequency [Hz], δ is a speed regulation rate (an increase rate of the frequency with respect to the reference frequency fₙ/a decrease rate of the output with respect to the reference electric output uₙ), and du is a governor-free signal (GF signal) for adjusting the supply and demand for the power. The GF signal du may be calculated using an electrical angular velocity of a rotating shaft of a generator instead of the frequency f as an approximation of Expression (8).

$$du = \frac{1}{δ} \frac{{u}_{n}}{{f}_{n}} ( {f}_{n} - f ) \qquad ( 8 )$$

The power generation control device 2 performs the supply and demand adjustment in accordance with the GF signal du with the equilibrium point signal u₁ of the electric output as a center. The equilibrium point signal u₁ corresponds to a state where a level of the electric output of the power plant gradually changes over, for example, several minutes. In contrast, the GF signal du changes in units of seconds. The command value u of the electric output that is commanded by the power generation control device 2 to the power plant is the sum of the equilibrium point signal u₁ and the GF signal du as in Expression (9).

u=du+u₁ (9)

In the power generation control device 2 of the present embodiment, the adjustment unit 22 entrusts the equilibrium point signal u₁ to an integral value of a deviation between the frequency f of the power grid and the reference frequency fₙ. As the frequency f of the power grid, a value measured at a connection point between the power plant and the power grid for each power plant may be used, or a value measured at a representative point of the region may be used as a common value for all the power plants in the region. Since the frequency f of the power grid is approximately normally distributed around the reference frequency fₙ (50 Hz or 60 Hz), in general, a time average value of the OF signal du is 0. Therefore, the GF signal du does not affect an amount of power supplied by the power plant.

The integral value of the deviation of the frequency f of the power grid from the reference frequency fₙ represents a long-term tendency of the deviation of the frequency f from the reference frequency fₙ. For example, when the supply and demand for the power is balanced, the frequency f fluctuates up and down randomly around the reference frequency fₙ. In this case, the integral value of the deviation does not change in fact.

In addition, for example, when the supply of the power is insufficient, the frequency f is offset to the negative side with respect to the reference frequency fₙ. In such a case, the integral value of the deviation increases with time. That is, the equilibrium point signal u* increases with time, and the level of the electric output of the power plant increases. As described in Expression (7), the profit of the power plant is maximized at the electric output u*, and the profit is rather impaired when the electric output exceeds the maximum. In order to prevent this situation, the adjustment unit 22 sets the upper limit of the equilibrium point signal u₁ to u*.

On the contrary, when the power supply is excessive, the frequency f is offset to the positive side with respect to the reference frequency fₙ. In such a case, the integral value of the deviation decreases with time. That is, the equilibrium point signal u₁ decreases with time, and the level of the electric output of the power plant decreases.

Since the power generation control device 2 autonomously adjusts the level of the electric output of each power plant to compensate for the unbalance between the power supply and demand, the supply and demand adjustment of the entire power system can also be autonomously and naturally achieved. In addition, since each power plant is operated in accordance with the command of the electric output of the power generation control device 2, the supply and demand adjustment in which, when one power generation company increases the output, another power generation company decreases the output by the increase amount as in the power system in the related art is not performed. That is, the power generation control device 2 can suppress the unfair bias of the benefit or the disadvantage to some power generation companies.

### Functional Configuration of Power Generation Control Device; Modification Example

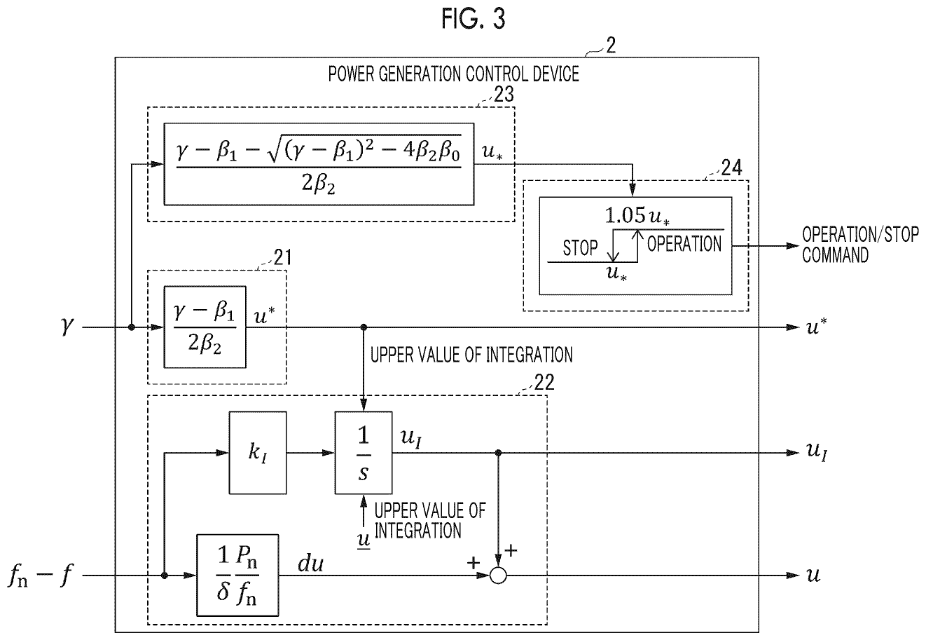

In addition, the power generation control device 2 may autonomously determine the operation and the stop of the power plant. Hereinafter, the technique will be described with reference to FIG. 3.

FIG. 3 is a second block diagram illustrating the functional configuration of the power generation control device according to the first embodiment.

As illustrated in FIG. 3, the power generation control device 2 may further include a minimum value determination unit 23 and a control unit 24. The minimum value determination unit 23 determines a minimum value u* of the electric output at which the profit of the power plant becomes zero, based on the unit price γ for the generated power. The control unit 24 controls the operation start or the operation stop of the power plant based on the minimum value u* of the electric output at which the profit becomes zero, and the equilibrium point signal u₁.

The details of the processing of the power generation control device 2 illustrated in FIG. 3 will be described. As the level of the electric output decreases, the profit of the power plant decreases accordingly, and the profit becomes zero somewhere. For simplicity, the description will be made on the assumption that the power plant stops the operation when the profit is equal to or less than zero. When the electric output at which the profit p becomes zero is referred to as u*, a value thereof is determined as in Expression (10A) by solving p=0.

$$u *= \frac{γ - {β}_{1} - \sqrt{{( γ - {β}_{1} )}^{2} - 4 {β}_{2} {β}_{0}}}{2 {β}_{2}} \qquad ( 10 A )$$

As illustrated in FIG. 3, the control unit 24 compares the electric output u* at which the profit becomes zero with the equilibrium point signal u₁ of the power plant. For example, when the power plant is stopped, the control unit 24 determines to start the operation when u₁≥1.05 u* and outputs an operation command to the power plant. In addition, when the power plant is in operation, the control unit 24 determines to stop the operation when u₁≤u* and outputs a stop command to the power plant. Here, “1.05” is an example, and any value may be set for each power plant in accordance with the characteristics of the power plant. In Expression (10A), β₀ represents a fixed cost. There are two types of the fixed costs, for example, the fixed cost that does not occur when the operation is stopped, such as a cost for a lighting of a control room of the power plant, and the fixed cost that occurs even when the operation is stopped, such as the interest on the construction cost of the power plant. The fixed cost β₀ in Expression (10A) assumes the former, and it is assumed that β₀=0 after the operation is stopped. The control unit 24 may perform control of continuing the operation even when the profit is lower than zero to recover the fixed cost in a case where the latter is dominant in the fixed cost β₀. In addition, control of stopping the operation may be performed such that the operation is stopped when the profit reaches a predetermined value. The predetermined value may be zero or a negative value. When the operation is continued until the profit becomes a predetermined negative value −p*, u* is determined by Expression (10B). In the present example, the example has been described in which the operation stop is determined based on the profit. However, the profit is an example, and the operation stop may be determined based on, for example, sales γ×u.

$$u *= \frac{γ - {β}_{1} - \sqrt{{( γ - {β}_{1} )}^{2} - 4 {β}_{2} ( {β}_{0} - p *}}{2 {β}_{2}} \qquad ( 10 B )$$

### (Functional Configuration of Aggregation Device and Unit Price Determination Device)

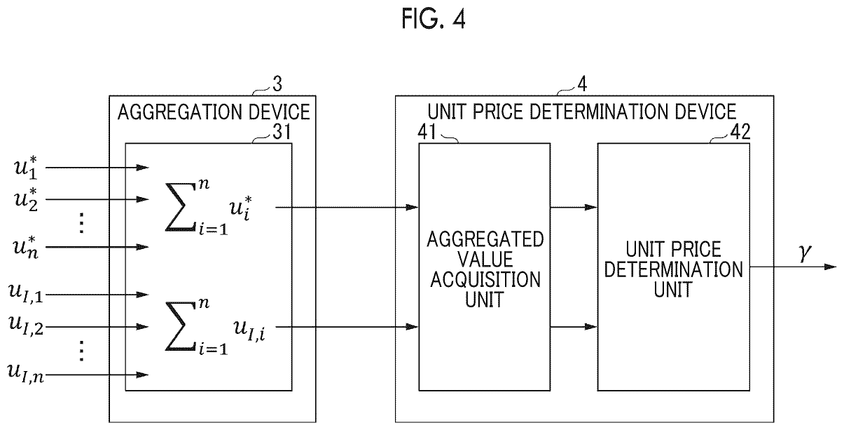

FIG. 4 is a block diagram illustrating functional configurations of the aggregation device and the unit price determination device according to the first embodiment.

The functional configurations of the aggregation device 3 and the unit price determination device 4 will be described with reference to FIG. 4.

The aggregation device 3 includes an aggregation unit 31 that aggregates the optimal value u* of the electric output in accordance with the unit price γ and the equilibrium point signal u₁ from the power generation control devices 2 of the plurality of power plants 1, 2, . . . , n.

The unit price determination device 4 includes an aggregated value acquisition unit 41 and a unit price determination unit 42. The aggregated value acquisition unit 41 acquires an aggregated value of the optimal value u* and an aggregated value of the equilibrium point signal u₁ from the aggregation device 3. The unit price determination unit 42 determines the unit price γ for the generated power based on the aggregated value of the optimal value u* and the aggregated value of the equilibrium point signal u₁.

FIGS. 1 and 4 illustrated an example in which the aggregation device 3 and the unit price determination device 4 are different devices, but the present disclosure is not limited to this. In another embodiment, the aggregation device 3 and the unit price determination device 4 may be configured as one device.

Each power plant has the upper limit value u* of the electric output. Assuming that n power plants are in operation in a certain region, the maximum value of the power generation in the entire region is obtained by Σu* obtained by summing u* of the n power plants. On the other hand, an actual total power generation amount in the region is Σu₁ obtained by summing u₁ at n locations. When Σu* is sufficiently large with respect to Σu₁, there is no need to worry about the increase margin in the power supply for the entire region. However, when Σu₁≈Σu*, there is no room for the increase margin. In this case, it is necessary to secure the increase margin by operating an additional power plant.

The minimum electric output at which the power plant can obtain the profit p (the profit p becomes positive) is u* calculated by Expression (10). Since a value of ∂u*/∂γ obtained by differentiating u* with respect to γ is negative, when the unit price γ for the generated power increases, u* decreases, and there is a power plant that obtains a positive profit p even in the currently stopped state. Accordingly, the increase margin can be increased. In addition, the upper limit value u* of the electric output in consideration of the profit of the power plant that is currently in operation is determined by Expression (7), but the value of ∂u*/∂γ (obtained by differentiating u* with respect to γ is positive, and an additional increase margin can be obtained from the power plant that is currently in operation. In this way, when the unit, price γ for the generated power increases, the increase margin of the power supply capacity increases.

Therefore, the unit price determination device 4 sets the unit price γ for the generated power to be low when the increase margin is excessive, and sets the unit price γ for the generated power to be high when the increase margin is insufficient. The processing of the unit price determination device 4 will be described in detail with reference to FIG. 4.

For example, an appropriate value m of the increase margin may be determined based on the power supply amount Σu₁ in the region, and the increase margin may be calculated by using Expression (11). γ₀ is a reference value of the unit price, and K_{γ} is a positive proportional coefficient. The expression for calculating the unit price γ is not limited to a linear function. A general polynomial or an exponential function may be adopted.

$$γ = {γ}_{0} + {K}_{γ} \cdot ( {m}_{0} - ( {\sum }_{i = 1}^{n} {u}_{i}^{*} - {\sum }_{i = 1}^{n} {u}_{I , i} ) ) \qquad ( 11 )$$

In addition, when the unit price determination device 4 notifies the power generation control device 2 of each power plant of the unit price γ for the generated power, as described above, in the power system 10, the electric output is adjusted or the operation/stop is controlled in each power plant, and the supply and demand adjustment or securing of the increase margin is autonomously performed.

### (Operations and Effects)

As described above, the power generation control device 2 according to the present embodiment includes the optimal value determination unit 21 that determines the optimal value u* of the electric output of the power plant based on the unit price γ for the generated power supplied to the power grid, and the adjustment unit 22 that adjusts the command value u of the electric output in accordance with the frequency f of the power grid by using the optimal value u* as the upper limit of the electric output.

In this way, the power generation control device 2 can autonomously perform the supply and demand adjustment in the entire power system 10 at each power plant. In addition, since each power plant is operated in accordance with the command of the electric output of the power generation control device 2, the supply and demand adjustment in which, when one power generation company freely increases the output, another power generation company decreases the output by the increase amount as in the power system in the related art is not performed. That is, the power generation control device 2 can suppress the unfair bias of the benefit or the disadvantage to some power generation companies.

In addition, the adjustment unit 22 of the power generation control device 2 calculates, by the integration control, the equilibrium point signal u₁ that is the value of the electric output for bringing the deviation between the frequency f of the power grid and the reference frequency fₙ to approach zero and that uses the optimal value u* of the electric output as the upper limit, and adjusts the command value u of the electric output based on the equilibrium point signal u₁.

In this way, the power generation control device 2 can enable each power plant to obtain the profit from the power generation and can stabilize the supply and demand balance of the power grid.

In addition, the power generation control device 2 further includes the minimum value determination unit 21 that determines the minimum value u* of the electric output at which the profit of the power plant becomes zero, based on the unit price γ, and the control unit 24 that controls the operation start or the operation stop of the power plant baud on the minimum value u* of the electric output and the equilibrium point signal u₁.

In this way, the power generation control device 2 can operate or stop the power plant such that the power plant can more reliably obtain the profit or such that the profit does not become negative.

In addition, the unit price determination device 4 according to the present embodiment includes the aggregated value acquisition unit 41 that acquires, from each of the plurality of power plants, the aggregated value of the optimal value u* of the electric output in accordance with the unit, price γ for the generated power supplied to the power grid, and the aggregated value of the equilibrium point signal u₁ that is an output target value for bringing the frequency f of the power grid to approach the reference frequency fₙ, and the unit price determination unit 42 that determines the unit price f based on the aggregated value of the optimal value u* and the aggregated value of the equilibrium point signal u₁.

In this way, the unit price determination device 4 can enable the adjustment of the electric output or the operation/stop control in each power plant and the autonomous supply and demand adjustment and securing of the increase margin, by increasing or decreasing the unit price γ.

### Modification Example of First Embodiment

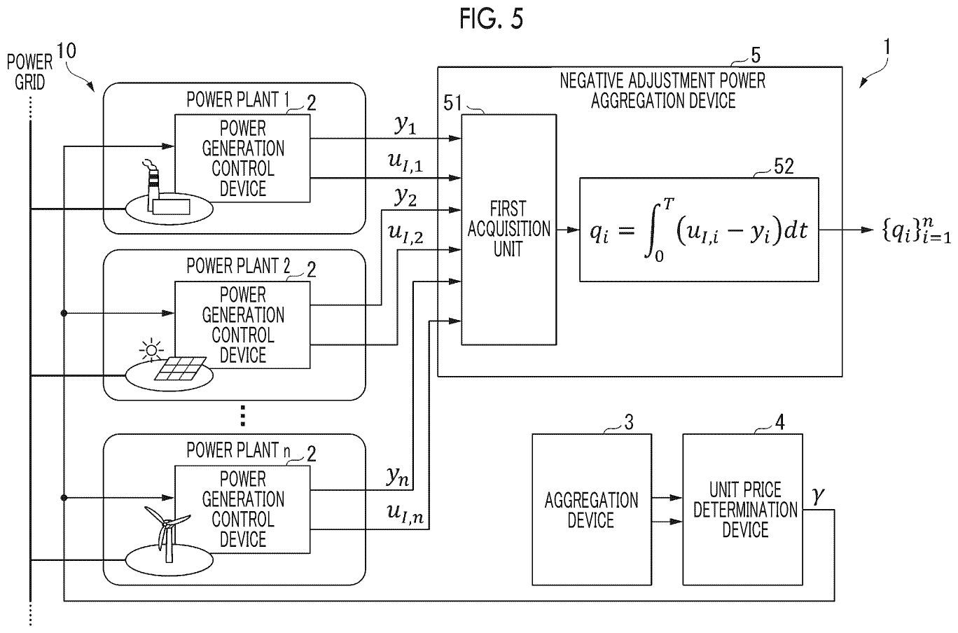

FIG. 5 is a diagram illustrating an overall configuration of a power supply control system according to a modification example of the first embodiment.

As illustrated in FIG. 5, the power supply control system 1 according to the present modification example may further include a negative adjustment power aggregation device 5. The negative adjustment power aggregation device 5 can aggregate, for example, an amount of power generated in excess (negative adjustment power) in a case where the power plant generates the power in excess of the demand in the power grid.

The negative adjustment power aggregation device 5 includes a first acquisition unit 51 and a negative adjustment power calculation unit 52. The first acquisition unit 51 acquires the equilibrium point signal u₁ and an actual measured value y of the electric output of the power plant front each of the power generation control devices 2 of the plurality of power plants. The negative adjustment power calculation unit 52 integrates a difference between the actual measured value y of the electric output and the equilibrium point signal u₁, to calculate an amount of power q generated in excess (negative adjustment power). The actual treasured value y of the electric output is power [kW] measured at the connection point between the power plant and the power grid.

In order for the power system 10 to be established, it is important to adjust the supply and demand, that is, to snatch the power supplied by the power plant with the demand. This is achieved by each power plant adjusting the output in accordance with the equilibrium point signal u₁ in the technique described in the first embodiment. However, there is a possibility that a certain power plant may generate more power than the equilibrium point signal u₁ in order to increase the profit. As illustrated in FIG. 5, the negative adjustment power calculation unit 52 integrates the difference between the actual measured value y of the electric output of each power plant and the equilibrium point signal u₁, as the amount of power q. In a case where the power plant generates the power in excess of the equilibrium point signal u₁, the amount of power q represents the negative adjustment power. In addition, the negative adjustment power calculation unit 52 may impose a penalty of reducing consideration (sales) for the power supply by subtracting, for example, the amount of power generated in excess (negative adjustment power) during a predetermined settlement target period (for example, one day) from the total amount of power supplied to the power grid by the power plant during the predetermined settlement target period.

The negative adjustment power aggregation device 5 can monitor whether or not each power plant appropriately performs the supply and demand adjustment, by aggregating the amount of power generated in excess of the equilibrium point signal u₁ by the power plant as the negative adjustment power in this way. Monitoring the negative adjustment power acts as a deterrent to excessive power generation, and can contribute to the stabilization of the supply and demand balance of the power grid. In addition, when an amount corresponding to the negative adjustment power is deducted from the consideration for the power generation amount of the power plant, it is possible to more reliably suppress excessive power generation of the power plant.

### Second Embodiment

The power supply control system 1 according to a second embodiment improves the profit p of the power generation company in a case where the power generation company owns the plurality of power plants.

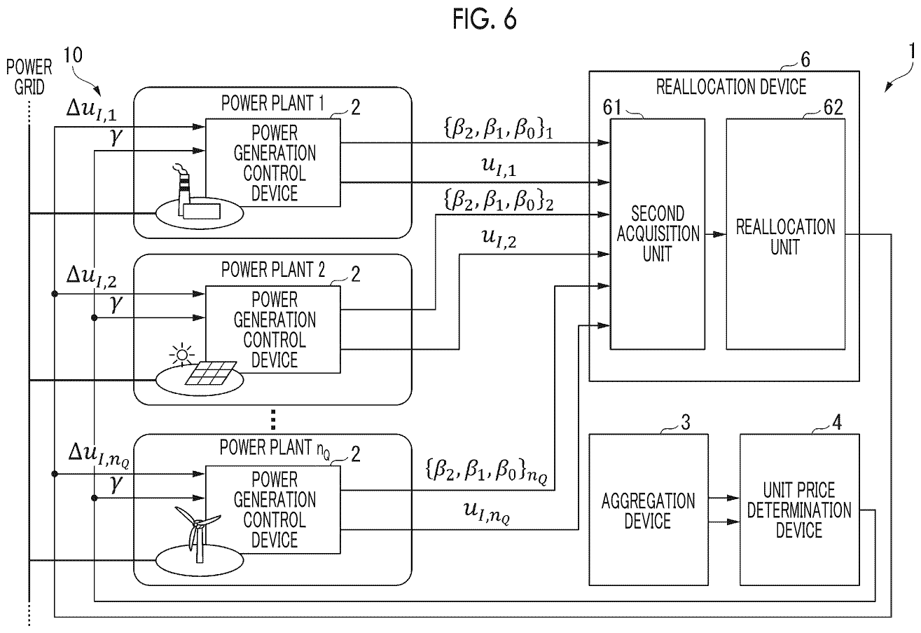

FIG. 6 is a diagram illustrating an overall configuration of a power supply control system according to a modification example of the second embodiment.

In the example of FIG. 6, it is assumed that one power generation company owns power plants 1, 2 . . . , n_{Q} among the plurality of power plants that supply the power to a certain region. The power plants 1, 2, . . . , n_{Q} are owned by one power generation company are collectively referred to as the power plant group. The power supply control system 1 further includes a reallocation device 6. The reallocation device 6 reallocates the electric output of each of the power plants 1, 2, . . . , n_{Q} belonging to the power plant group.

The reallocation device 6 includes a second acquisition unit 61 and a reallocation unit 62. The second acquisition unit 61 acquires the equilibrium point signal u₁, which is the output target value for bringing the frequency of the power grid close to the reference frequency, and the coefficient related to the cost required for the power generation, from each of the power plants belonging to the power plant group. The reallocation unit 62 reallocates the electric output of each of the power plants belonging to the power plant group such that the power generation cost of the entire power plant group is minimized, based on the equilibrium point signal u₁ and the coefficient β.

FIG. 6 illustrates an example in which the reallocation device 6 is added to the power supply control system 1 (FIG. 1) according to the first embodiment, but the present disclosure is not limited to this. The reallocation device 6 may be added to the power supply control system 1 (FIG. 5) according to the modification example of the first embodiment.

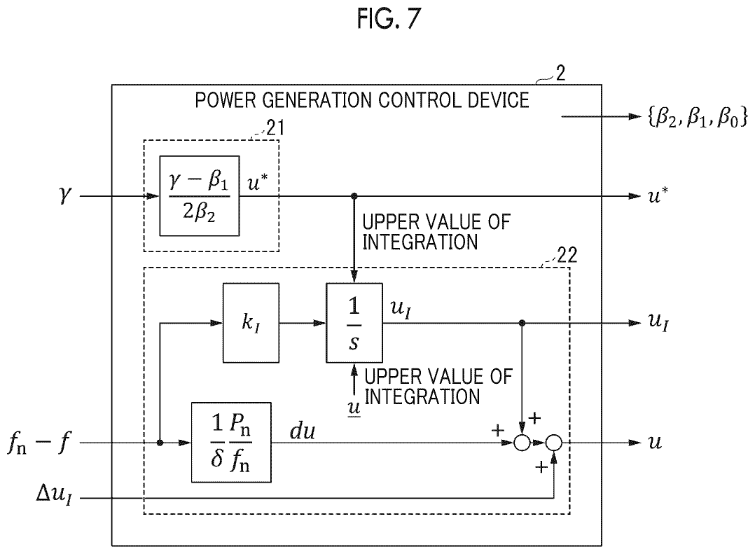

FIG. 7 is a block diagram illustrating a functional configuration of the power generation control device according to the second embodiment.

In the power generation control device 2 according to the present embodiment, the adjustment unit 22 further adjusts the command value u of the electric output based on the electric output reallocated by the reallocation device 6.

When the power generation company owns the plurality of power plants, the power generation company has the freedom to select the power plant to be used, and generally, the power generation company is expected to select a combination of power plants in consideration of economy. When a combination of power plants in operation by a certain power generation company is referred to as Q, the total electric output supplied by the power generation company is obtained by the following Expression (12).

$${u}_{Q} = {\sum }_{i ∈ Q} {u}_{l , i} \qquad ( 12 )$$

In FIG. 6, for simplification, a specific example is shown in which Q={1, 2, . . . , n_{Q}}. The actual Q is not always a serial number. The total electric output for the combination Q of power plants is calculated based on the equilibrium point signal u₁ of each of the power plants included in the combination. The reason of the above is to avoid fluctuations in the total electric output caused by the GF signal that fluctuates in a short time.

In the power system 10 in which the power generation is liberalized, the total electric output supplied by the power generation company is determined front the balance between the supply and demand of the power, and is given for the power generation company. Therefore, the power generation company pursues the profit by generating total electric output u_{Q} at a lower cost. When the power generation company owns the plurality of power plants, the power generation company has the freedom to select the power plant to be used as described above. Further, the power generation company can increase the profit by increasing the distribution of the total electric output u_{Q} to the power plant with high efficiency and stopping the power plant with low efficiency or reducing the distribution thereto. Since changing the output distribution of the power plant while maintaining the total electric output supplied by the power generation company is generally expressed as “switching”, the present embodiment also follows this, and a method of the switching will be described with reference to FIGS. 6 to 9.

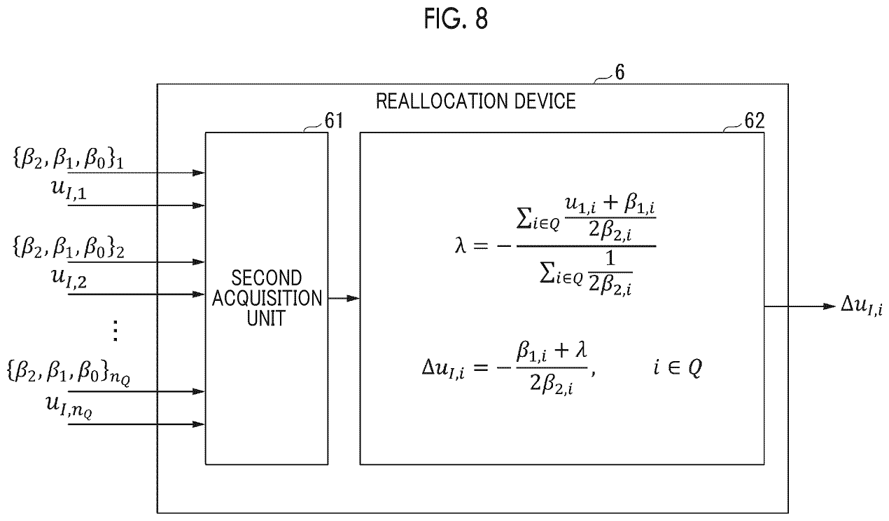

FIG. 8 is a first diagram illustrating a function of the reallocation device according to the second embodiment.

It is assumed that the power generation company operates the power plant group having the combination Q. When the combination of power plants to be operated is given, the optimal switching can be achieved by the equal incremental fuel cost method. In a case where the switching is performed in the combination Q, the equal incremental fuel cost method is expressed as an optimization problem as in the following Expression

$$minimized {\sum }_{i ∈ Q} {c}_{i} subject to {\sum }_{i ∈ Q} {Δ u}_{I , i} = 0 \qquad ( 13 )$$

In Expression (13), Δu_{1,i} is the electric output that the power plant i, which is an element of Q, switches. Since the electric output of the entire combination Q before and after the switching has to remain unchanged, the sum of Δu_{1,i} is 0. Expression (13) represents an optimization problem of minimizing the sum of the costs c of this power generation costs of each of the combinations Q, with this as a constraint condition.

The optimization problem of Expression (13) can be solved by the Lagrange multiplier method. When a Lagrange multiplier is λ, and a Lagrange function L(Δu₁,λ) is set as in Expression (14), the optimal values of Δu₁ and λ are Δu₁∈R^{nQ} and λ∈R₁ that satisfy the simultaneous expression of Expression (15).

$$L ( {Δ u}_{I} , λ ) = - {\sum }_{i ∈ Q} {c}_{t} - λ {\sum }_{i ∈ Q} {Δ u}_{I , i} \qquad ( 14 )$$

$$\{ \begin{matrix}\frac{\partial L}{\partial Δ u} = 0 \\ \frac{\partial L}{\partial λ} = 0\end{matrix} \qquad ( 15 )$$

When the two expressions are expanded, a system of expressions of n_{Q}+1th order in Expression (16) is obtained.

$$\{ \begin{matrix}- \frac{\partial {c}_{i}}{\partial {Δ u}_{I , i}} - λ = 0 , & i ∈ Q \\ {\sum }_{i ∈ Q} {Δ u}_{I , i} = 0 & \end{matrix} \qquad ( 16 )$$

When the cost e is expanded, Expression (17) is obtained.

$$\{ \begin{matrix}- 2 {β}_{2 , i} ( {Δ u}_{I , i} + {u}_{I , i} ) - {β}_{1 , i} - λ = 0 , & i ∈ Q \\ {\sum }_{i ∈ Q} {Δ u}_{I , i} = 0 & \end{matrix} \qquad ( 17 )$$

Expression (17) is a linear simultaneous linear expression for the Lagrange multiplier λ and Δu₁, and an optimal solution is obtained as in Expression (18) and Expression (19).

$$λ = - \frac{{\sum }_{i ∈ Q} \frac{{u}_{1 , i} + {β}_{1 , i}}{2 {β}_{2 , i}}}{{\sum }_{i ∈ Q} \frac{1}{2 {β}_{2 , i}}} \qquad ( 18 )$$

$${Δ u}_{I , i} = - \frac{{β}_{1 , i} + λ}{2 {β}_{2 , i}} , i ∈ Q \qquad ( 19 )$$

As illustrated in FIGS. 6 and 8, the reallocation device 6 inputs the equilibrium point signal u₁ and the parameters {β₂, β₁, β₀} representing the power generation cost front the power plant in operation, and outputs the electric output Δu₁ to be switched. FIG. 7 illustrates how the electric output Δu₁ to be switched is reflected in the electric output u. The electric output Δu₁ to be switched is reflected in the electric output u in the same manner as the GF adjustment signal. The electric output to be switched is irrelevant to the equilibrium point signal u₁. This is to strictly ensure that the equilibrium point signal u₁ is determined only based on the frequency f. Since the sum of the electric output Δu₁ to be switched is 0 for the combination Q of power plants in operation, whether or not the electric output Δu₁ to be switched is reflected in the equilibrium point signal u₁ is irrelevant to the function of the negative adjustment power aggregation device 5 according to the modification example (FIG. 5) of the first embodiment, so that there is no problem in handling in this way.

There is a limit to a change speed of the electric output in each power plant. For example, it is not possible to increase the electric output from 0% output to 100% output in one second. Therefore, the change speed of Δu₁ may be limited such that the value of the electric output Δu₁ to be switched is not suddenly changed. For example, a time change rate of the electric output to be switched may be limited to be followable even in the power plant having the slowest change speed of the electric output. When the change speed of the electric output that each power plant switches is limited, in determining the change speed, the change speed may be limited such that the time change rate does not affect Expression (12) by using Expression (20) as a constraint condition.

$${\sum }_{i ∈ Q} \frac{{d Δ u}_{I , i}}{dt} = 0 \qquad ( 20 )$$

In the reallocation processing (using the equal incremental fuel cost method), the calculations of Expression (18) and Expression (19) are repeatedly performed at all times, and thus the switching is performed in a temporally continuous manner. In this manner, the optimal load distribution is achieved in real time.

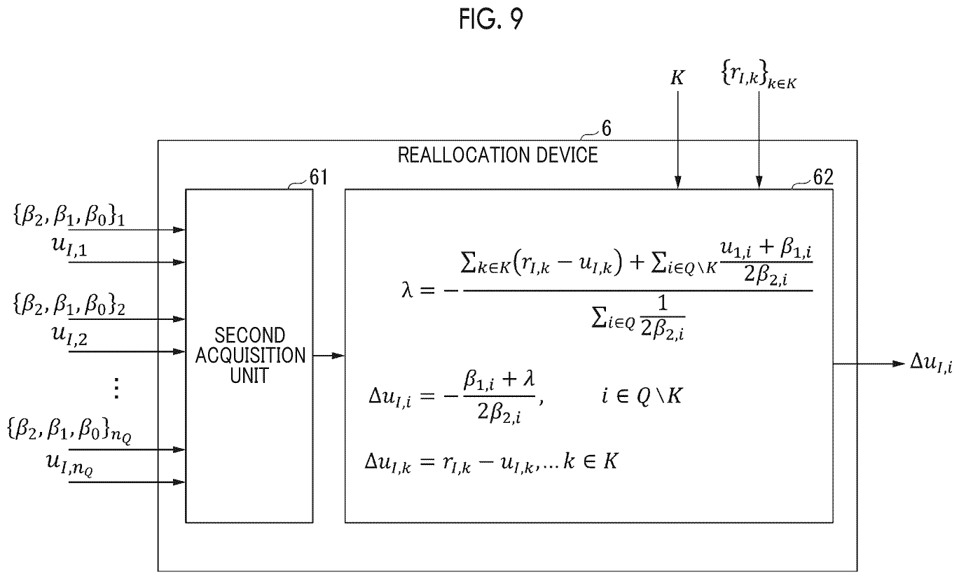

The power generation company that owns the plurality of power plants has the freedom to select and use an efficient power plant from among the owned power plants, and thus the power generation company is expected to select the optimal power plant in terms of economy. The demand for the power changes with time. For example, since production activities are active during the daytime, the demand for the power is high, and since most production activities are stopped, the demand for the power is low during the nighttime. When the demand fluctuates with time in this way, the optimal combination of power plants has to also be changed accordingly. The power generation company reviews the combination Q of power plants to be operated by the processing of optimizing the combination, which is separately performed. The review of the combination Q of power plants to be operated is any of (1) stopping the power plant included in the combination Q, (2) newly adding the power plant to the combination Q, and (3) maintaining the combination Q. Of these, the processing of (3) is as illustrated in FIG. 8. In (2), a new power plant is merely added to Q. The processing performed by the electric output reallocation device after the addition is exactly the same as (3). In (1), it is necessary to partially change the processing of the reallocation unit 62 of the reallocation device 6, and thus (1) will be described below with reference to FIG. 9.

FIG. 9 is a second diagram illustrating the function of the reallocation device according to the second embodiment.

It is assumed that, before the review, the power generation company operates the power plant group having the combination Q and stops the power plant k in the combination Q. The remaining power plants are power plants obtained by removing the power plant k from the combination Q. and are referred to as Q\k. The total electric output before the power plant k is stopped has to be switched to the remaining power plants after the power plant k is stopped. This is a constraint condition and is expressed by Expression (21).

$$- {u}_{j , k} + {\sum }_{i ∈ Q \backslash k} {Δ u}_{I , i} = 0 \qquad ( 21 )$$

The optimization problem of minimizing the cost with Expression (21) as a constraint condition is expressed by Expression (22).

$$minimize {\sum }_{i ∈ Q \backslash k} {c}_{i} subject to - {u}_{I , k} + {\sum }_{i ∈ Q \backslash k} {Δ u}_{I , i} = 0 \qquad ( 22 )$$

This problem can also be solved by the Lagrange multiplier method as described above. Specifically, Expression (23) and Expression (24) are used.

$$λ = - \frac{{u}_{I , k} + {\sum }_{i ∈ Q \backslash k} \frac{{u}_{1 , i} + {β}_{1 , i}}{2 {β}_{2 , i}}}{{\sum }_{i ∈ Q \backslash k} \frac{1}{2 {β}_{2 , i}}} \qquad ( 23 )$$

$${Δ u}_{l , i} = - {u}_{I , i} - \frac{{β}_{1 , i} + λ}{2 {β}_{2 , i}} , i ∈ Q \backslash k \qquad ( 24 )$$

Regarding the power plant k to be stopped, the electric output has to be changed from the current value u_{1,k} to 0, and thus the electric output to be switched is expressed by Expression (25).

Δu_{1,k}=u_{1,k} (25)

In such a case, Expression (12) is also satisfied in a case of “(1) stopping the power plant included in the combination Q”. Therefore, a difference between a case of “(1) stopping the power plant included in the combination Q” (FIG. 9) described here and a case of “(3) maintaining the combination Q” t FIG. 8) described above is determined by the presence or absence of externally designating the output of the power plant as in the power plant k to be stopped, instead of leaving the output of the power plant, to the equal incremental fuel cost method. When everything is left to the equal incremental fuel cost method. (3) is adopted, and when everything is not left to the equal incremental fuel cost method not, (1) is adopted.

The power plant that externally specifies the output is expressed by a symbol k. There may be a plurality of k, and a set of k is expressed by K. That is, when K={1, 2, . . . , n_{K}} and k□K, a value of Δu_{1,k} is externally specified. In this case, the problem of externally designating the electric output of the power plant belonging to K as r_{1,k} and optimizing the output of the power plant not belonging to K (that is, belonging to the set Q\K) by the equal incremental fuel cost method without changing the total output of the power plants Q in operation as in Expression (12) is expressed as in Expression (26). For example, in a case where the power plant k is stopped. K=[k] and r_{1,k}=0 kW may be set. In addition, for example, in a case where the power plant k is stopped and the power plant k+1 is set to 100 MW, K={k,k+1} and r_{1,k}+1=100 MW may be set.

$$minimize {\sum }_{i ∈ Q \backslash k} {c}_{i} subject to - {\sum }_{k ∈ K} {Δ u}_{I , k} + {\sum }_{i ∈ Q \backslash k} {Δ u}_{I , i} = 0 \qquad ( 26 )$$

$${Δ u}_{I , k} = {r}_{I , k} - {u}_{I , k} , k ∈ K$$

As described above, in the power supply control system 1 according to the present embodiment, in a case where the power generation company owns a plurality of power plants, the profit of the power generation company can be increased by reallocating the electric output of each power plant by the reallocation device 6.

### <Hardware Configuration>

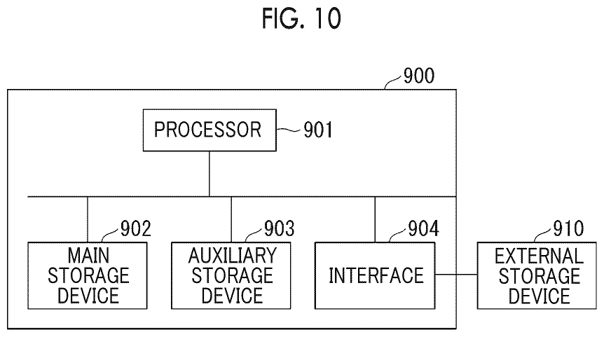

FIG. 10 is a diagram illustrating an example of a hardware configuration of a distribution device according to at least one embodiment.

Hereinafter, an example of a hardware configuration of each device provided in the power supply control system 1 will be described with reference to FIG. 10.

As illustrated in FIG. 10, a computer 900 includes a processor 901, a main storage device 902, an auxiliary storage device 903, and an interface 904

The power generation control device 2, the aggregation device 3, the unit price determination device 4, the negative adjustment power aggregation device 5, and the reallocation device 6 described in each of the above-described embodiments are respectively implemented in the computer 900. Then, the operation of each of the above-described processing units is stored in an auxiliary storage device 903 in a form of a program. The processor 901 reads the program from the auxiliary storage device 903, loads the program into the stain storage device 902, and executes the processing in accordance with the program. In addition, the processor 901 secures a storage area for various types of processing in the main storage device 902 in accordance with the program. In addition, the processor 901 secures a storage area for storing data being processed in the auxiliary storage device 903 in accordance with the program.

The program may be used to implement a part of the functions exerted by the computer 900. For example, the program may exhibit a function in combination with another program already stored in the auxiliary storage device 903 or in combination with another program installed in another device. In another embodiment, the computer 900 may include a custom large scale integrated (LSI) circuit such as a programmable logic device (PLD), in addition to or instead of the above-described configuration. Examples of the PLD include a programmable array logic (PAL), a generic array logic (GAL), a complex programmable logic device (CPLD), and a field programmable gate array (FPGA). In this case, a part or all of the functions implemented by the processor 901 may be implemented by the integrated circuit.

Examples of the auxiliary storage device 903 include a hard disk drive (HDD), a solid state drive (SSD), a magnetic disk, a magneto-optical disk, a compact disc read only memory (CD-ROM), a digital versatile disc read only memory (DVD-ROM), and a semiconductor memory. The auxiliary storage device 903 may be an internal medium that is directly connected to a bus of the computer 900, or may be an external storage device 910 that is connected to the computer 900 via the interface 904 or a communication line, in a case where this program is distributed to the computer 900 via the communication line, the computer 900 that has received the distribution may load the program into the main storage device 902 and execute the above-described processing. In at least one embodiment, the auxiliary storage device 903 and the external storage device 910 are non-transitory tangible storage media.

As described so far, some embodiments according to the present invention have been described, but all of these embodiments are presented as examples and are not intended to limit the scope of the invention. These embodiments can be implemented in various other forms, and various omissions, replacements, and changes can be made without departing from the gist of the invention. These embodiments and modifications thereof are included within the scope or the gist of the invention, and also included within the scope of the invention as described in the claims and equivalents thereof.

### <Supplementary Note>

The power generation control device, the unit price determination device, the power supply control system, the power generation control method, and the program described in the above-described embodiments are understood, for example, as follows.

(1) A first aspect of the present disclosure relates to a power generation control device 2 that is provided in each of a plurality of power plants, the power generation control device 2 including: an optimal value determination unit 21 that determines an optimal value u* of electric output of the power plant based on a unit price γ for generated power supplied to a power grid; and an adjustment unit 22 that adjusts a command value u of the electric output in accordance with a frequency f of this power grid by using the optimal value u* as an upper limit of the electric output.

In this way, the power generation control device 2 can autonomously perform the supply and demand adjustment in the entire power system 10 at each power plant. In addition, since each power plant is operated in accordance with the command of the electric output of the power generation control device 2, the supply and demand adjustment in which, when one power generation company increases the output, another power generation company decreases the output by the increase amount as in the power system in the related art is not performed. That is, the power generation control device 2 can suppress the unfair bias of the benefit or the disadvantage to some power generation companies.

(2) A second aspect of the present disclosure relates to the power generation control device 2 according to the first aspect, in which the adjustment unit 22 calculates, by integration control, an equilibrium point signal u₁ that is a value of the electric output adjusted such that a deviation between the frequency f of the power grid and a reference frequency fₙ approaches zero and that uses the optimal value u* as an upper limit, and adjusts the command value u of the electric output based on the equilibrium point signal u₁.

In this way, the power generation control device 2 can enable each power plant to obtain the profit from the power generation and can stabilize the supply and demand balance of the power grid.

(3) A thine aspect of the present disclosure relates to the power generation control device 2 according to the second aspect, further including: a minimum value determination unit 23 that determines a minimum value u* of the electric output at which a profit p of the power plant becomes a predetermined value, based on the unit price γ; and a control unit 24 that controls an operation start or an operation stop of the power plant based on the minimum value u* and the equilibrium point signal u₁.

In this way, the power generation control device 2 can operate or stop the power plant such that the power plant can more reliably obtain the profit or such that the profit does not become negative.

(4) A fourth aspect of the present disclosure relates to a unit price determination device 4 including: an aggregated value acquisition unit 41 that acquires, from each of a plurality of power plants, an aggregated value of an optimal value u* of electric output in accordance with a unit price γ for generated power supplied to a power grid, and an aggregated value of an equilibrium point signal u₁ that is a value of the electric output adjusted such that a deviation between a frequency f of the power grid and a reference frequency fₙ approaches zero; and a unit price determination unit 42 that determines the unit price γ based on the aggregated value of the optimal value u* and the aggregated value of the equilibrium point signal u₁.

In this way, the unit price determination device 4 can enable the adjustment of the electric output or the operation/stop control in each power plant and the autonomous supply and demand adjustment and securing of the increase margin, by increasing or decreasing the unit price γ.

(5) A fifth aspect of the present disclosure relates to a power supply control system 1 that controls power supplied to a power grid, the power supply control system 1 including: the power generation control device Z according to any one of the first to third aspects; and the unit price determination device 4 according to the fourth aspect.

(6) A sixth aspect of the present disclosure relates to the power supply control system 1 according to the fifth aspect, further including: a negative adjustment power aggregation device 5 that aggregates negative adjustment power of each of the plurality of power plants. The negative adjustment power aggregation device 5 includes a first acquisition unit 51 that acquires, from each of the plurality of power plants, an equilibrium point signal to that is a value of the electric output adjusted such that a deviation between a frequency f of the power grid and a reference frequency fₙ approaches zero, and an actual measured value y of the electric output of the power plant, and a negative adjustment power calculation unit 52 that integrates a difference between the actual measured value y of the electric output and the equilibrium point signal u₁, to calculate an amount of power that is generated in excess, as the negative adjustment power q.

In this way, the power supply control system 1 can monitor whether or not each power plant appropriately performs the supply and demand adjustment by aggregating the negative adjustment power by the negative adjustment power aggregation device 5. Monitoring the negative adjustment power acts as a deterrent to excessive power generation, and can contribute to the stabilization of the supply and demand balance of the power grid. In addition, when an amount corresponding to the negative adjustment power is deducted front the consideration for the power generation amount of the power plant, it is possible to more reliably suppress excessive power generation of the power plant.

(7) A seventh aspect of the present disclosure relates to the power supply control system 1 according to the fifth or sixth aspect, further including: a reallocation device 6 that reallocates, in a power plant group including two or more power plants among the plurality of power plants, electric output of each of the power plants belonging to the power plant group. The reallocation device 6 includes a second acquisition unit 61 that acquires, from each of the power plants belonging to the power plant group, an equilibrium point signal u₁ that is a value of the electric output adjusted such that a deviation between a frequency f of the power grid and a reference frequency fₙ approaches zero, and a coefficient β related to a cost required for power generation, and a reallocation unit 62 that reallocates the electric output of each of the power plants belonging to the power plant group such that a power generation cost of an entire power plant group is minimized, based on the equilibrium point signal u₁ and the coefficient β.

In this way, the power supply control system 1 can reallocate the electric output of each of the power plants belonging to the power plant group, to increase the profit of the entire power plant group. The power plant group includes, for example, the plurality of power plants owned by one power generation company. The power generation company can generate the power to be supplied by the power plant group owned by the power generation company at the lowest cost, and thus the profit of the power generation company can be increased accordingly.

(8) An eighth aspect of the present disclosure relates to the power supply control system 1 according to the seventh aspect, in which the adjustment unit 22 of the power generation control device 2 further adjusts the command value u of the electric output based on the electric output reallocated by the reallocation device 6.

In this way, the power supply control system 1 can autonomously and efficiently operate the power plant belonging to the power plant group at the minimum power generation cost.

(9) A ninth aspect of the present disclosure relates to a power (generation control method including: a step of determining an optimal value u of electric output of the power plant based on a unit price γ for generated power supplied to a power grid; and a step of adjusting a command value u of the electric output in accordance with a frequency f of the power grid by using the optimal value u* as an upper limit of the electric output.

(10) A tenth aspect of the present disclosure relates to a program causing a power generation control device 2 provided in each of a plurality of power plants to execute: a step of determining an optimal value u* of electric output of the power plant based on a unit price γ for generated power supplied to a power grid; and a step of adjusting a command value u of the electric output in accordance with a frequency f of the power grid by using the optimal value u* as an upper limit of the electric output.

### INDUSTRIAL APPLICABILITY

According to the above-described aspects, in the power system in which each of the plurality of power generation companies supplies the generated power, it is possible to adjust the electric output in accordance with the unit price and the demand for the generated power while suppressing the unfair bias of the benefit or the disadvantage to some power generation companies.

### REFERENCE SIGNS LIST

1: power supply control system
10: power system
2: power generation control device
21: optimal value determination unit
22: adjustment unit
23: minimum value determination unit
24: control unit
3: aggregation device
31: aggregation unit
4: unit price determination device
41: aggregated value acquisition unit
42: unit price determination unit
5: negative adjustment power aggregation device
51: first acquisition unit
52: negative adjustment power calculation unit
6: reallocation device
61: second acquisition unit
62: reallocation unit
900: computer
901: processor
902: main storage device
903: auxiliary storage device
904: interface
910: external storage device

1. A power generation control device that is provided in each of a plurality of power plants, the power generation control device comprising:
an optimal value determination unit that determines an optimal value of electric output of the power plant based on a unit price for generated power supplied to a power grid; and
an adjustment unit that adjusts a command value of the electric output in accordance with a frequency of the power grid by using the optimal value as an upper limit of the electric output.

2. The power generation control device according to claim 1,
wherein the adjustment unit calculates, by integration control, an equilibrium point signal that is a value of the electric output adjusted such that a deviation between the frequency of the power grid and a reference frequency approaches zero and that uses the optimal value as an upper limit, and adjusts the command value of the electric output based on the equilibrium point signal.

3. The power generation control device according to claim 2, further comprising:
a minimum value determination unit that determines a minimum value of the electric output at which a profit of the power plant becomes a predetermined value, based on the unit price; and
a control unit that controls an operation start or an operation stop of the power plant based on the minimum value and the equilibrium point signal.

4. (canceled)

5. A power supply control system that controls power supplied to a power grid, the power supply control system comprising:
the power generation control device according to claim 1.

6. The power supply control system according to claim 5, further comprising:
a negative adjustment power aggregation device that aggregates negative adjustment power of each of the plurality of power plants,
wherein the negative adjustment power aggregation device includes
a first acquisition unit that acquires, from each of the plurality of power plants, an equilibrium point signal that is a value of the electric output adjusted such that a deviation between a frequency of the power grid and a reference frequency approaches zero, and an actual measured value of the electric output of the power plant, and
a negative adjustment power calculation unit that integrates a difference between the actual measured value of the electric output and the equilibrium point signal, to calculate an amount of power that is generated in excess, as the negative adjustment power.

7. The power supply control system according to claim 5, further comprising:
a reallocation device that reallocates, in a power plant group including two or more power plants among the plurality of power plants, electric output of each of the power plants belonging to the power plant group,
the reallocation device includes
a second acquisition unit that acquires, from each of the power plants belonging to the power plant group, an equilibrium point signal that is a value of the electric output adjusted such that a deviation between a frequency of the power grid and a reference frequency approaches zero, and a coefficient related to a cost required for power generation, and
a reallocation unit that reallocates the electric output of each of the power plants belonging to the power plant group such that a power generation cost of an entire power plant group is minimized, based on the equilibrium point signal and the coefficient.

8. The power supply control system according to claim 7,
wherein the adjustment unit of the power generation control device further adjusts the command value of the electric output based on the electric output reallocated by the reallocation device.

9. A power generation control method comprising:
a step of determining an optimal value of electric output of the power plant based on a unit price for generated power supplied to a power grid; and
a step of adjusting a command value of the electric output in accordance with a frequency of the power grid by using the optimal value as an upper limit of the electric output.

10. A non-transitory computer readable medium storing a program causing a power generation control device provided in each of a plurality of power plants to execute:
a step of determining an optimal value of electric output of the power plant based on a unit price for generated power supplied to a power grid; and
a step of adjusting a command value of the electric output in accordance with a frequency of the power grid by using the optimal value as an upper limit of the electric output.
